(19) United States
(12) Patent Application Publication
(10) Pub. No.: US 2020/0034940 A1
(43) Pub. Date: Jan. 30, 2020

(54) CONTRACT GENERATION AND TEMPLATING

(71) Applicant: Opendoor Labs Inc., San Francisco, CA (US)

(72) Inventors: Chintan Parikh, San Francisco, CA (US); Kai Cathy Chen, San Francisco, CA (US); Alexander Zirbel, San Francisco, CA (US)

(21) Appl. No.: 16/195,000

(22) Filed: Nov. 19, 2018

Related U.S. Application Data
(60) Provisional application No. 62/702,887, filed on Jul. 24, 2018.

(51) Int. Cl. G06Q 50/16; G06F 17/24

(52) U.S. Cl. CPC G06Q 50/163; G06F 17/214; G06F 17/243

(57) ABSTRACT

Systems and methods are disclosed for receiving a selection of a real-estate property transaction associated with a real-estate property, determining an attribute of the real-estate property, identifying, based on the determined attribute of the real-estate property, one or more real-estate property transaction documents associated with the selected real-estate property transaction, and identifying a format for the identified one or more real-estate property transaction documents based on the attribute of the real-estate property. The systems and methods further provide for obtaining information associated with the real-estate property transaction and automatically populating the one or more real-estate property transaction documents according to the identified format using the obtained information.

### CROSS-REFERENCE TO RELATED APPLICATION

This application claims the benefit of priority of Chintan Parikh et al., U.S. Provisional Patent Application No. 62/702,887, entitled “CONTRACT GENERATION AND TEMPLATING,” filed on Jul. 24, 2018 (Attorney Docket No. 4815.005PRV), the entirety of which is hereby incorporated by reference herein.

### BACKGROUND

Real-estate property transactions across different states and between different property types involve many types of documents at each step of the transaction. Certain properties or states may require one type of document to complete a real-estate property transaction while others may require a different type of document. Determining which type of document to use in a given real-estate property transaction and in a given jurisdiction is very complicated, time consuming, involves many parties (e.g., lawyers, brokers, marketers, etc.) and is expensive. Sometimes due to the complexities involved in creating the real-estate property transaction documents, errors may end up in the documents which require creation of even more documents to correct the errors.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system for automatically creating real-estate property transaction documents, according to some example embodiments.

FIG. 2 illustrates a document integration system, according to some example embodiments.

FIGS. 3-5 illustrate flow diagrams of processes for automatically creating real-estate property transaction documents, according to some example embodiments.

FIGS. 6-8 are illustrative user interfaces for providing an output of the document integration system, according to some example embodiments.

FIG. 9 is a block diagram illustrating an example of a software architecture that may be installed on a machine, according to some example embodiments.

FIG. 10 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments. It will be evident, however, to those skilled in the art, that embodiments may be practiced without these specific details. In general, well-known instruction instances, protocols, structures, and techniques are not necessarily shown in detail.

Accurately creating real-estate property transaction documents is key to performing real-estate property transactions. For example, a buyer who is considering purchasing a given real-estate property typically needs to work with a real-estate broker and a real-estate lawyer to determine which types of documents are needed in the particular jurisdiction. For example, in a first jurisdiction, the buyer needs to sign a broker representation agreement and a purchase and sale agreement to purchase a given real-estate property. In a second jurisdiction, additional addendums may need to be completed and attached to the purchase and sale agreement that are not needed in the first jurisdiction. Inaccurately determining which documents need to be created and completed to conduct the real-estate property transaction in a given jurisdiction can have catastrophic consequences. For example, a buyer who fails to complete a required document in the given jurisdiction required to complete a sale of the real-estate property may end up wasting time going back to the lawyer to prepare the right documents which may delay closing the purchase. This may result in additional fees having to be incurred by the seller or purchaser or worse having to request and pay for an extension on a loan interest lock that is in place pending closing of the purchase.

The tools available for creating real-estate property transaction documents can automate filling in various fields in the documents by having the user input the text corresponding to those fields. For example, existing tools allow the user to select a given type of real-estate property document or form and automatically output the form based on the user supplied information for various fields. But such existing tools still require the user to not only select the right documents to fill out but also to manually input all the information into the fields in the form. Mistakenly choosing the wrong documents to create or mistakenly inputting the wrong information (e.g., because of a typographical or clerical error) can end up delaying the real-estate property transaction. Further, determining the right type of document to complete is typically not trivial and requires significant research because rules, laws and regulations change regularly and vary from one jurisdiction to the next.

The disclosed embodiments improve the efficiency and accuracy of real-estate property document creation systems by identifying an attribute of a real-estate property (e.g., a jurisdiction or property type) associated with a selected real-estate property transaction and automatically identifying and populating the correct set of real-estate property documents suitable based on the identified attribute. The automatic identification and population of the correct set of real-estate property documents allows the disclosed embodiments to accurately create the right set of real-estate property documents for a given real-estate property transaction with minimal user input (e.g., without the user having to manually select which documents to complete and input all the information for each document). This significantly reduces the amount of research and time a user needs to spend creating documents necessary to complete a real-estate property transaction and increases the overall accuracy of the real-estate property documents that are created. This provides real-estate property buyers and sellers with an accurate set of documents they need to complete a given transaction quickly and efficiently and avoids potential catastrophic consequences resulting from mistakenly choosing and populating the wrong documents.

According to some embodiments, a user selection of a real-estate property transaction (e.g., a real-estate property purchase transaction) associated with a real-estate property is received. Based on this selection, the system, according to the disclosed embodiments, determines an attribute of the real-estate property (e.g., a jurisdiction or property type) and automatically identifies one or more real-estate property transaction documents (e.g., a purchase and sale agreement and/or various addendums) associated with the selected real-estate property transaction based on the attribute of the real-estate property. The system, according to the disclosed embodiments, identifies a format for the identified one or more real-estate property transaction documents, obtains information associated with the transaction and automatically populates the documents according to the identified format using the obtained information. For example, the system determines the ordering scheme for the documents and size and automatically retrieves the address and publicly available information about the property (e.g., the current owner of the property) to automatically populate the fields (e.g., the address and seller fields) of the purchase and sale agreement as well as any addendums that have the same information.

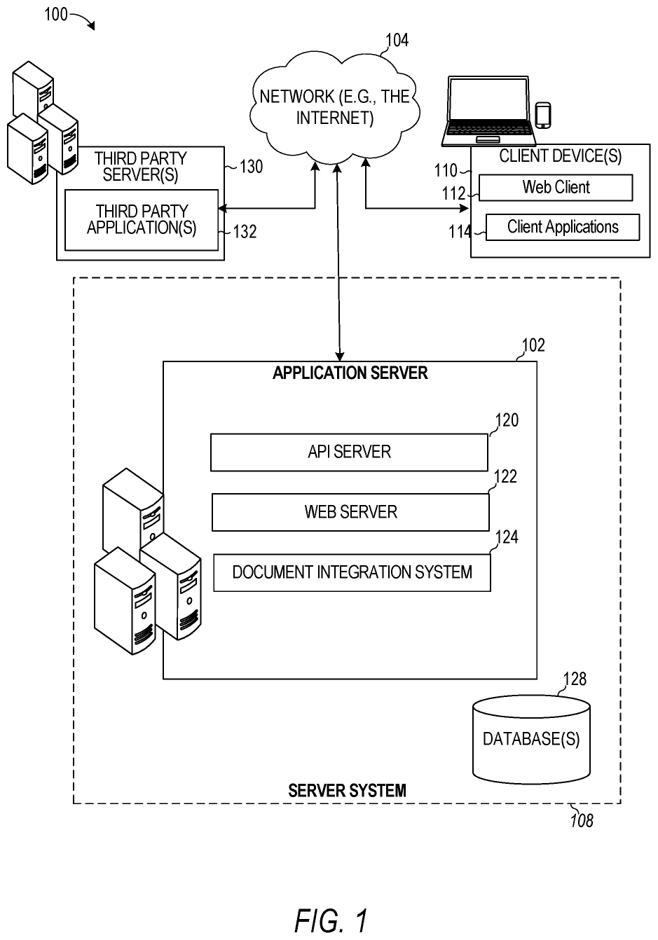

FIG. 1 is a block diagram illustrating a networked system 100, according to some example embodiments, configured to automatically create real-estate property transaction documents. The system 100 includes one or more client devices such as client device 110. The client device 110 comprises, but is not limited to, a mobile phone, desktop computer, laptop, portable digital assistants (PDA), smart phone, tablet, ultrabook, netbook, laptop, multi-processor system, microprocessor-based or programmable consumer electronic, game console, set-top box, computer in a vehicle, or any other communication device that a user may utilize to access the networked system 100. In some embodiments, the client device 110 comprises a display module (not shown) to display information (e.g., in the form of user interfaces). In further embodiments, the client device 110 comprises one or more of touch screens, accelerometers, gyroscopes, cameras, microphones, global positioning system (GPS) devices, and so forth. The client device 110 may be a device of a user that is used to access and utilize home buying services (e.g., request one or more documents to be created for a given real-estate property transaction). For example, the client device 110 may be used to input information to request an automated offer on a subject real-estate property, to request a value of a subject real-estate property, to request one or more real-estate property transaction documents to be automatically selected and populated, to make an offer on a subject real-estate property, to receive and display various information about a subject real-estate property or a market, to view different real-estate property transaction documents needed in different jurisdictions, to preview real-estate property documents that are automatically created, and so forth.

For example, client device 110 is a device of a given user who would like to sell his or her subject real-estate property. Client device 110 accesses a website of the home buying and selling service (e.g., hosted by server system 108). The user inputs an address of the subject real-estate property and selects an option to receive an automated offer or value of the subject real-estate property in the web site. Server system 108 receives the request and identifies comps (e.g., a plurality of real-estate properties) having similar attributes as the subject real-estate property. Server system 108 automatically retrieves characteristics of the subject real-estate property based on the address and search for comps within a predetermined distance (e.g., 1.2 miles) of the address of the subject real-estate property. Server system 108 then automatically computes a value for the subject real-estate property and provides the value to the client device 110 instantly or after a period of time (e.g., 24 hours). In some circumstances, server system 108 involves an operator of a website of the home buying and selling service using an operator device to review the value that was automatically computed before the value is returned to the client device 110. Client device 110 receives the value and provides an option to the user to complete the real-estate transaction. For example, the user selects an option to complete the sale of the real-estate property. In response, server system 108 automatically generates one or more real-estate property transaction documents (e.g., a contract for sale of the subject real-estate property) and allows the user to execute the documents to complete the sale. After the user executes the documents the subject real-estate property enters a pending status. Server system 108 may present a list of available closing dates to the user. Once the user selects the closing date, the subject real-estate property closes at the contract price on the closing date.

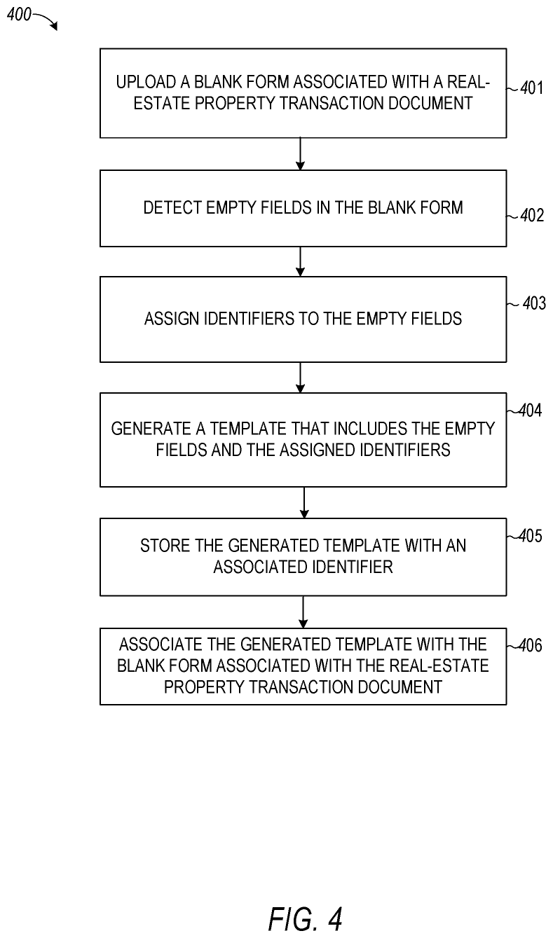

As another example, client device 110 is a device of an operator of server system 108. The operator uses client device 110 to input and upload one or more real-estate property transaction forms and to specify which forms are associated with which jurisdiction or property types. Once the form is uploaded by the client device 110, server system 108 automatically identifies blank entries in the form and generates a template for the form and assigns an identifier to the template. The template is stored with the identifier and is associated with the blank form. Each template may be associated with multiple jurisdictions or property types or may be unique to a particular jurisdiction or property type. The process for generating templates is discussed below in connection with FIG. 4. As referred to herein, a document form is a blank physical or electronic document that is used to conduct one or more real-estate property transactions. The document form includes various fields that are unique and specific to every real-estate property transaction that need to be filled in to complete the real-estate property transaction. As referred to herein, a document template is a data structure that includes various fields that each represents a given blank field of a given document form. Once the fields of a document template are populated, the corresponding information can be added to the form associated with the template in order to provide a completed real-estate property transaction form that can be used to conduct the real-estate property transaction.

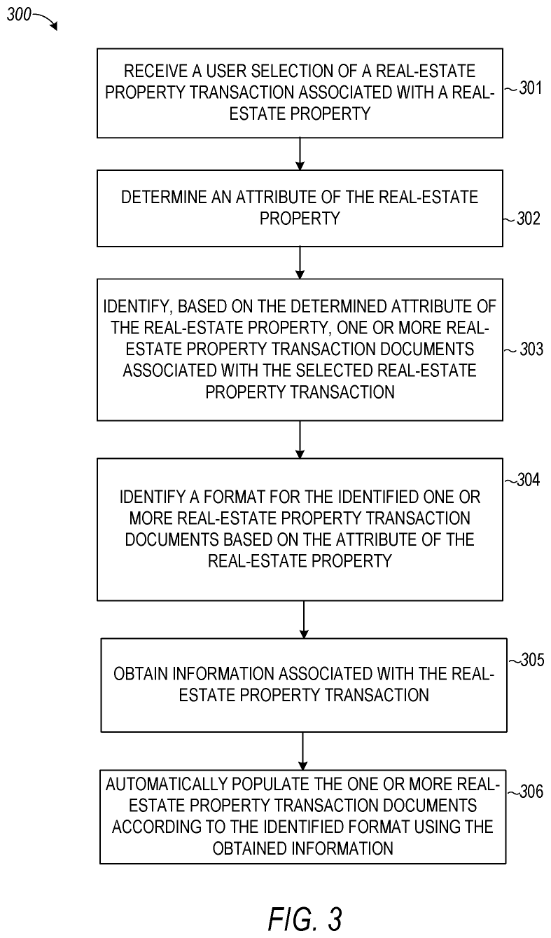

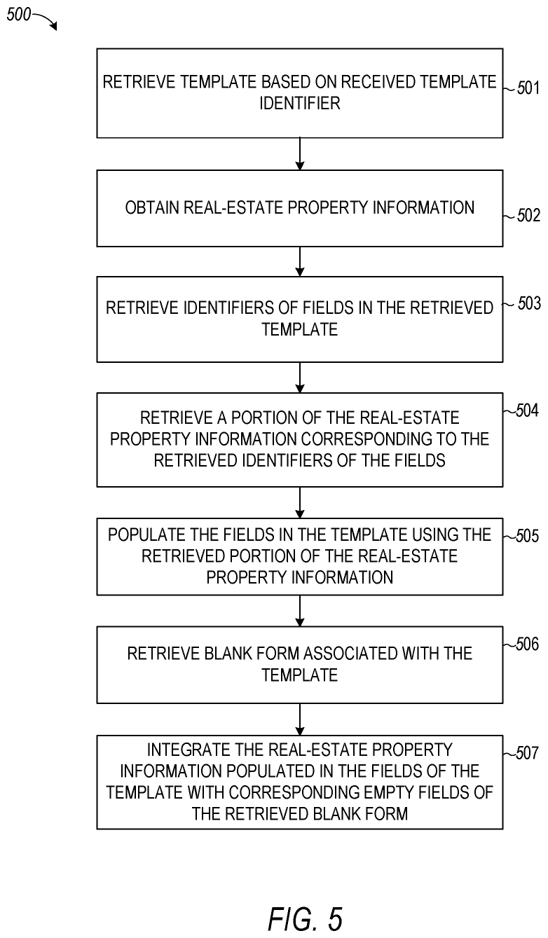

As another example, client device 110 is a device of a given user who would like to conduct a real-estate property transaction. The user accesses the server system 108 via client device 110. Server system 108 presents to the user at the client device 110 a user interface that allows the user to select a real-estate property transaction (e.g., a purchase and sale transaction). The client device 110 communicates the user's selection of the real-estate property transaction and also some additional information (e.g., a name of the buyer/seller, property address, purchase price, etc.) and the server system 108 automatically identifies the attributes (e.g., the jurisdiction of the property) and the types of real-estate property transaction documents that are necessary to complete the real-estate property transaction. Server system 108 automatically populates the real-estate property transaction documents and may request some additional input from the user at the client device 110 for missing information. For example, server system 108 searches for a template identifier corresponding to the selected real-estate property transaction. Server system 108 identifies a plurality of real-estate property transaction documents associated with the template identifier and retrieves templates corresponding to each of the identified real-estate property transaction documents. After populating automatically various fields of the real-estate property transaction document templates, server system 108 retrieves the corresponding real-estate property transaction document form associated with each template and fills in the information into the real-estate property transaction document forms based on the populated template. Once the real-estate property transaction document form is automatically completed, server system 108 may transmit the completed form to the user at client device 110 (e.g., by email, instant message, stored folder or any other means). The process for automatically populating real-estate property transaction templates and forms is discussed below in connection with FIGS. 3 and 5.

One or more users may be a person, a machine, or other means of interacting with the client device 110. In example embodiments, the user may not be part of the system 100, but may interact with the system 100 via the client device 110 or other means. For instance, the user may provide input (e.g., touch screen input or alphanumeric input) to the client device 110 and the input may be communicated to other entities in the system 100 (e.g., third-party servers 130, server system 108, etc.) via the network 104. In this instance, the other entities in the system 100, in response to receiving the input from the user, may communicate information to the client device 110 via the network 104 to be presented to the user. In this way, the user interacts with the various entities in the system 100 using the client device 110.

The system 100 further includes a network 104. One or more portions of network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 may access the various data and applications provided by other entities in the system 100 via web client 112 (e.g., a browser, such as the Internet Explorer® browser developed by Microsoft® Corporation of Redmond, Wash. State) or one or more client applications 114. The client device 110 may include one or more client applications 114 (also referred to as “apps”) such as, but not limited to, a web browser, messaging application, electronic mail (email) application, an e-commerce site application, a mapping or location application, an online home buying and selling application, a real estate application, and the like.

In some embodiments, one or more client applications 114 are included in a given one of the client device 110, and configured to locally provide the user interface and at least some of the functionalities, with the client application 114 configured to communicate with other entities in the system 100 (e.g., third-party servers 130, server system 108, etc.), on an as-needed basis, for data and/or processing capabilities not locally available (e.g., to access location information, to access market information related to homes, to authenticate a user, to verify a method of payment, etc.). Conversely, one or more applications 114 may not be included in the client device 110, and then the client device 110 may use its web browser to access the one or more applications hosted on other entities in the system 100 (e.g., third-party servers 130, server system 108, etc.).

A server system 108 provides server-side functionality via the network 104 (e.g., the Internet or wide area network (WAN)) to one or more third-party servers 130 and/or one or more client devices 110. The server system 108 includes an application program interface (API) server 120, a web server 122, a document integration system 124, that may be communicatively coupled with one or more databases 128. The one or more databases 128 may be storage devices that store data related to users of the system 108, applications associated with the system 108, cloud services, housing market data, and so forth. The one or more databases 128 may further store information related to third-party servers 130, third-party applications 132, client devices 110, client applications 114, users, and so forth. In one example, the one or more databases 128 may be cloud-based storage.

The server system 108 may be a cloud computing environment, according to some example embodiments. The server system 108, and any servers associated with the server system 108, may be associated with a cloud-based application, in one example embodiment.

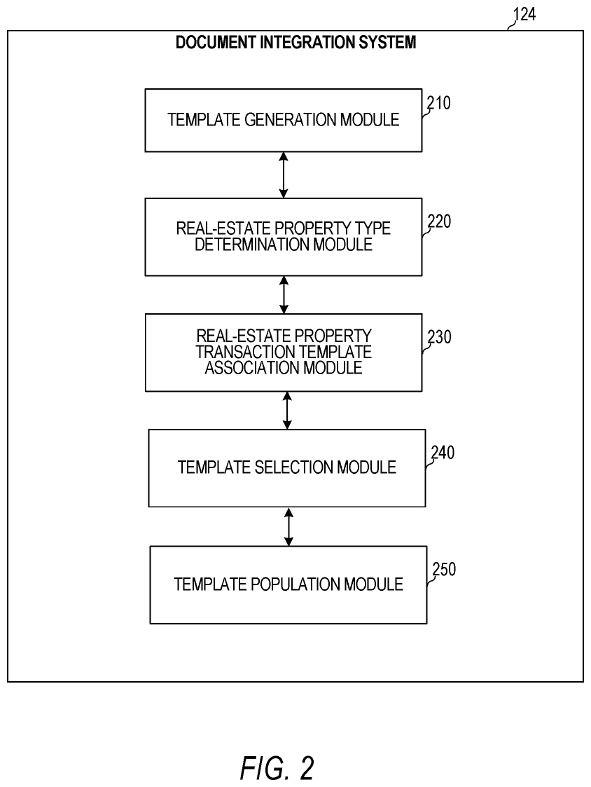

The server system 108 includes a document integration system 124. Document integration system 124 includes one or more storage devices and databases. The storage devices in document integration system 124 store various real-estate property transaction documents (e.g., forms and templates). The databases in document integration system 124 are programmed with logic for each type of real-estate property transaction document that identifies for each real-estate property transaction document a set of corresponding real-estate property transaction forms, templates and formats for a given property attribute (e.g., a market in which the real-estate property exists). For example, for one market, a real-estate property purchase transaction requires a first set of documents. For another market, the same real-estate property purchase transaction requires a second set of documents. In another example, a real-estate property of a certain age or that was constructed during a particular time period, requires one set of documents that are not required for a similar property that was more recently constructed. These and other relationships between the documents and the real-estate property attributes are stored in the databases in document integration system 124. The details of the document integration system 124 are provided below in connection with FIG. 2.

In some embodiments, the relationships between documents stored in document integration system 124 are updated by an operator as new markets, regulations or laws are implemented or promulgated. For example, a new law requires additional addendums to be added to purchase agreements in a given market (e.g., New York). Accordingly, an operator accesses document integration system 124 (e.g., via client device 110) and adds a reference to the additional addendum for the New York market for a purchase agreement. If the form for the additional addendum has not been previously uploaded and does not have a corresponding template, the operator uploads the appropriate form and instructs the document integration system 124 to generate the template for the form. When a given user (e.g., a buyer or seller) selects a real-estate property transaction such as purchase and inputs the New York market, the system 108 may determine based on the information in document integration system 124 that a purchase agreement document is needed and the additional New York market addendum is needed. In response, the document integration system 124 automatically populates the purchase agreement in accordance with the New York market specific format and also retrieves the related New York market addendum and populate its fields with the data corresponding to the buyer and seller. The user does not need to be familiar with the recent legal changes requiring the need for this additional addendum which saves time, money and avoids errors in creating the real-estate property transaction document.

In some embodiments, changes in a market require different document formats. In such circumstances, an operator generates a new document template in accordance with the new format and may upload a new form corresponding to the different document format. The operator may update the links that reference the previous document form and template stored in document integration system 124 to reference the new document form and template. This enables quick updates to the document integration system 124 as market conditions and the laws change over time. There is no need to manually change the look and feel of the already stored documents. The new documents will be generated in accordance with the new format as users request new real-estate transaction documents to be created.

The system 100 further includes one or more third-party servers 130. The one or more third-party servers 130 may include one or more third-party application(s) 132. The one or more third-party application(s) 132, executing on third-party server(s) 130, may interact with the server system 108 via API server 120 via a programmatic interface provided by the API server 120. For example, one or more the third-party applications 132 may request and utilize information from the server system 108 via the API server 120 to support one or more features or functions on a website hosted by the third party or an application hosted by the third party. The third-party website or application 132, for example, may provide software version analysis functionality that is supported by relevant functionality and data in the server system 108.

Third-party servers 130 may include a multiple listing service (MLS) server. This service is publicly accessible to real-estate brokers nationwide. A real-estate broker inputs property information to the MLS server (e.g., price information and property attributes) to list the property for sale. Other brokers can access the MLS server to search and filter properties available for sale or that have been sold and select a given property to view. The MLS server may allow a real-estate broker to provide an offer to purchase a given property being listed for sale on behalf of a buyer. The MLS server may indicate whether a given property listing is pending indicating that an executed purchase and sale agreement between a buyer and seller of the real-estate property has been received. Typically, the real-estate property closes or sells about 70 days following the receipt of the signed agreement to purchase the real-estate property.

The MLS server may include a database of real-estate properties. Characteristics of each property stored in the MLS server may also be provided. Characteristics include a location of the property, a school district, a tax rate, a home owners association rate, interior conditions (e.g., whether the property has been renovated, whether the property has stainless steel appliances, whether the property has a pool, whether the property has granite countertops), whether the property is characterized as new construction, whether the property has previously been occupied, and so forth. The information of the MLS server may be included as part of database 128. The MLS real-estate properties information may be used to search for comps to automatically determine a value of a subject real-estate property.

In an embodiment, third-party servers 130 provide functionality of generating or creating real-estate property transaction document templates. For example, an operator accesses third-party servers 130 using a given login and specifies a type of document template to create and store on the third-party servers 130 by uploading a given document form with blank fields. Exemplary types of real-estate property document templates for forms that can be created and stored on third party servers 130 are described below in Table 1. Each document template includes one or more fields. Exemplary fields corresponding to each document template are shown in Table 1. In response to the user selecting a given template from the list in Table 1, the user or third-party servers 130 accesses the corresponding fields associated with the selected document and generates and populates a real-estate property document form based on the template.

TABLE 1
Document Template Types and Available Fields

| Document | | |
|---|---|---|
| Type | Used For | Available Fields |
| Purchase | Purchase Contract | full address of property; block number of |
| Agreement | for the property | property; city of property; county of property; |
| | | buyer address; seller address; buyer name; |
| | | seller name; contract date |
| Acquisition | Any acquisition | full address of property; block number of |
| Generic | addendum that is | property; city of property; county of property; |
| Addendum | not a COE change | description of change to contract, dynamic |
| | or repair | based on type of addendum; |
| Acquisition | Changing | full address of property; block number of |
| Change Close | acquisition COE | property; city of property; county of property; |
| of Escrow | date | description of change to contract, dynamic |
| Addendum | | based on type of addendum; |
| Acquisition | Acquisition repair | full address of property; block number of |
| Repair | credit from seller | property; city of property; county of property; |
| Addendum | | description of change to contract, dynamic |
| | | based on type of addendum; |
| HOA (Home | Describing HOA | full address of property; block number of |
| Owner's | membership and | property; city of property; county of property; |
| Association) | fees for a property | HOA fee information; HOA membership |
| Addendum | | information |
| Listing Packet | The full packet of | full address of property; block number of |
| | documents for | property; city of property; county of property; |
| | listing a property | agent information; HOA fee information; |
| | on MLS | HOA membership information |

FIG. 2 illustrates a document integration system 124, according to some example embodiments. Document integration system 124 includes a template generation module 210, a real-estate property type determination module 220, a real-estate property transaction template association module 230, a template selection module 240 and a template population module 250. In some implementations, some modules of document integration system 124 may be implemented on server system 108 and others may be implemented on third party servers 130. In some implementations, all of the modules of document integration system 124 are implemented on server system 108 or on third party servers 130. In such cases, server system 108 communicates information to third party servers 130 based on the modules implemented and vice versa.

Template generation module 210 receives a blank form provided by an operator (e.g., a purchase and sale agreement). Template generation module 210 performs an optical character recognition process on the blank form to identify characters (e.g., a sequence of dashes or underlines) that represent areas of the form that can be populated with text or information. Template generation module 210 extracts each of these areas and analyzes text surrounding these areas to automatically assign an identifier to these areas. For example, a set of underline characters (e.g., “______”) followed by a parenthetical text with the word “buyer” is associated with the identifier buyer. Template generation module 210 adds each identifier as a field in a template and associates the field of the template with the exact location of the identified area in which the set of underline characters are present in the blank form. An operator may be presented with the template and can edit the identifiers assigned to the given area. For example, the operator may edit a field identified as “address” with “property address” to ensure that common field identifiers are commonly identified or represented across different templates. Specifically, a template for a purchase and sale agreement having the field for address should be labeled with the same name (e.g., “property address”) as another template for an addendum that also has a field for address. After the template is created for a given form, template generation module 210 assigns a unique or specific identifier to the template and associates the template with the corresponding blank form. Template generation module 210 stores the template in database 128.

Real-estate property type determination module 220 receives an address or identifier of a given real-estate property associated with a real-estate property transaction. Real-estate property type determination module 220 determines one or more attributes associated with the real-estate property. For example, real-estate property type determination module 220 determines the jurisdiction and age of the real-estate property. In some implementations, real-estate property type determination module 220 searches an external MLS database to determine the one or more attributes associated with the real-estate property. Real-estate property type determination module 220 communicates the determined one or more attributes to the template selection module 240 to retrieve the one or more templates associated with the real-estate property attributes.

Real-estate property transaction template association module 230 identifies a set of templates corresponding to a given real-estate property transaction. For example, real-estate property transaction template association module 230 stores a database that associates different real-estate property transactions with one or more templates. Specifically, real-estate property transaction template association module 230 associates a purchase and sale real-estate transaction with a purchase and sale agreement. As another example, real-estate property transaction template association module 230 associates a rental real-estate transaction with a rental agreement.

Template selection module 240 receives the identified real-estate template from the real-estate property transaction template association module 230 and receives the templates associated with the real-estate property attribute. Template selection module 240 retrieves the template identified by the real-estate property transaction template association module 230 and any additional templates that correspond to the particular property attribute. For example, template selection module 240 retrieves a purchase and sale agreement template that is specific to the jurisdiction identified by the real-estate property type determination module 220. Template selection module 240 also retrieves a set of additional templates corresponding to addendums specific to the jurisdiction identified by the real-estate property type determination module 220.

Template population module 250 obtains a set of information specific to the user requesting a particular set of documents for a given real-estate property transaction and populates the templates retrieved by the template selection module 240 using the obtained information. For example, template population module 250 receives an address of a property and searches an MLS database to identify a lot number and HOA fees associated with the property at the address. Template population module 250 may also retrieve the current owner of the property at the address from the MLS database. In this way, the user need only provide the address of the property associated with a selected real-estate property transaction and template population module 250 automatically retrieves a set of information associated with that address to populate templates and forms. This avoids the user having to provide additional input and possibly inputting wrong information which further avoids mistakes being included in real-estate property transaction documents. Template population module 250 identifies fields in the templates and matches the fields with the obtained information to automatically populate the fields. For example, template population module 250 determines that a “property address” field corresponds to a property address in the obtained information. Accordingly, template population module 250 inputs the obtained property address into the “property address” field(s) presented in the retrieved templates.

In some implementations, template population module 250 identifies fields in the retrieved templates for which information was not obtained. In such circumstances, template population module 250 may prompt a user to provide the information associated with the identified fields. After all of the fields in the template are populated (e.g., by a combination of manual user input and automatic population), template population module 250 identifies the forms associated with the template identifiers. Template population module 250 adds the information provided for each field in the template into the appropriate and associated location on the form to generate and create the form(s) associated with the populated templates. Template population module 250 stores, outputs (e.g., by way of a preview), or emails the populated form(s) to a user at client device 110.

FIGS. 3-5 illustrate flow diagrams of processes 300-500 for automatically generating real-estate property transaction documents, according to some example embodiments. The processes 300-500 may be embodied in computer-readable instructions for execution by one or more processors such that the operations of the processes 300-500 may be performed in part or in whole by the functional components of the server system 108; accordingly, the processes 300-500 are described below by way of example with reference thereto. However, in other embodiments at least some of the operations of the processes 300-500 may be deployed on various other hardware configurations. The processes 300-500 are therefore not intended to be limited to the server system 108 and can be implemented in whole, or in part, by any other component.

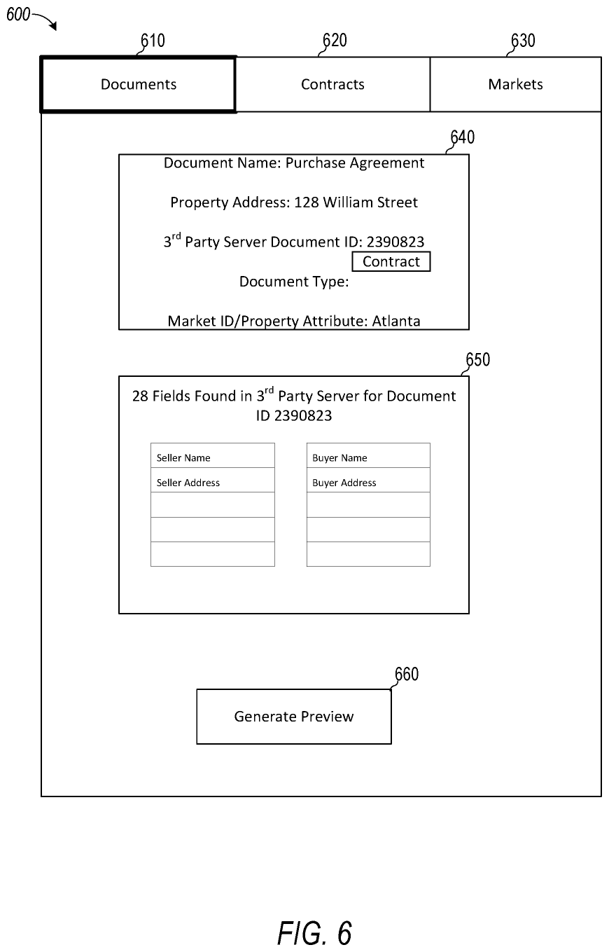

At operation 301, a computing system (e.g., server system 108) receives a user selection of a real-estate property transaction associated with a real-estate property. For example, a user may access server system 108 using client device 110. Server system 108 presents the user with a user interface 600 (FIG. 6) that allows the user to select a real-estate property transaction. For example, the user can select a documents option 610 and input a real-estate property transaction into real-estate property transaction information region 640. In one example, the user selects a purchase and sale transaction and inputs an address of the property associated with the transaction. In some implementations, a user inputs a specific identifier of a template for a real-estate transaction document into region 640.

At operation 302, the computing system determines an attribute of the real-estate property. For example, real-estate property type determination module 220 receives the address supplied by the user and accesses an MLS database to obtain one or more attributes associated with the property. As an example, real-estate property type determination module 220 determines the jurisdiction (e.g., New York) and age of the property at the address. Real-estate property type determination module 220 presents the determined attributes in information region 640.

At operation 303, the computing system identifies, based on the determined attribute of the real-estate property, one or more real-estate property transaction documents associated with the selected real-estate property transaction. For example, template selection module 240 identifies one or more real-estate property transaction documents associated with the selected real-estate property transaction and attributes of the real-estate property. Specifically, template selection module 240 retrieves from a database a list of template identifiers that are associated with the specified real-estate property transaction and the real-estate property attributes. Using the template identifiers, template selection module 240 retrieves the corresponding templates from storage 128. In some implementations, the computing system presents to the user at client device 110 a list of the available fields of each template in field identifier region 650.

At operation 304, the computing system identifies a format for the identified one or more real-estate property transaction documents based on the attribute of the real-estate property. For example, template selection module 240 retrieves from a database a format of template identifiers that are associated with the specified real-estate property transaction and the real-estate property attributes. Specifically, template selection module 240 determines that for a given jurisdiction, the addendums for a purchase and sale agreement are positioned before a listing document and after the signature page of the purchase and sale agreement. In another embodiment, template selection module 240 determines a required font size and type for populating real-estate property documents.

At operation 305, the computing system obtains information associated with the real-estate property transaction. For example, template population module 250 access an MLS database to obtain information corresponding to fields of the retrieved templates. For any field for which information is not found in the MLS database, template population module 250 requests or prompts a user to supply the information.

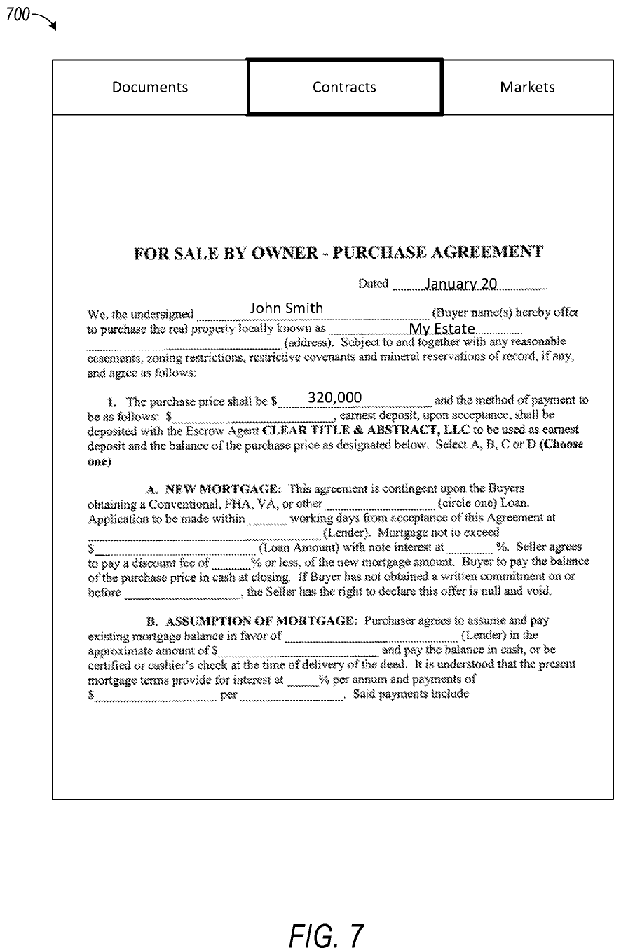

At operation 306, the computing system automatically populates the one or more real-estate property transaction documents according to the identified format using the obtained information. For example, template population module 250 fills in the information into the corresponding fields of the retrieved templates and then places the information from the fields of the templates in the appropriate locations and using the appropriate font into the corresponding blank form(s) associated with the templates. In some embodiments, template population module 250 adjusts a size and style of the font used to populate the blank forms based on a size of the available space for inserting the information in the form so that the information fits into the available space. An illustrative process for automatically populating the documents is discussed in connection with process 500 (FIG. 5). In some implementations, a user can select the generate preview option 660 (FIG. 6) and in response the computing system presents the form(s) to the user that have been populated with the obtained information in user interface 700 (FIG. 7). In some embodiments, a user can select the contracts option 620 to view the corresponding blank forms for the retrieved templates.

In order to enable the documents to be automatically populated, the computing system first generates one or more templates associated with each real-estate transaction document. An illustrative process for generating the templates is discussed below in connection with process 400.

At operation 401, the computing system uploads a blank form associated with a real-estate property transaction document. For example, template generation module 210 receives from a client device 110 a blank form for a real-estate property transaction. The client device 110 may indicate the type of form and the type of real-estate property transaction associated with the form. The client device 110 may also specify which types of real-estate property attribute is associated with the form.

At operation 402, the computing system detects empty fields in the blank form. For example, template generation module 210 performs optical character recognition to identify empty placeholder areas in the form. Specifically, template generation module 210 searches the form for regions containing blank space (e.g., “______”).

At operation 403, the computing system assigns identifiers to the empty fields. For example, template generation module 210 detects text nearby the empty fields. In one example, template generation module detects adjacent text in parenthesis next to the empty field. Template generation module 210 extracts the text (e.g., “buyer”) and assigns the extracted text as the identifier for the empty field. In some cases, template generation module 210 cannot discern an identifier based on the nearby text and in such cases, template generation module 210 requests user input to identify the empty fields. Template generation module 210 may present a portion of the form containing the detected empty field for which an identifier cannot be discerned automatically and the user may read the presented portion and input text that identifies the empty field.

At operation 404, the computing system generates a template that includes the empty fields and the assigned identifiers. For example, template generation module 210 aggregates all of the identifiers associated with the detected empty fields into different fields of a data structure and names the data structure based on the title of the uploaded document. Each field in the data structure may include information that specifies the specific position of the empty field corresponding to the identifier of the field. This position information is used to later insert text into the empty field to populate the form.

At operation 405, the computing system stores the generated template with an associated identifier. For example, template generation module 210 stores the template with a unique or specific identifier in database 128.

At operation 406, the computing system associates the generated template with the blank form associated with the real-estate property transaction document. For example, template generation module 210 identifies, based on the input from the operator supplied when the form was uploaded, one or more real-estate property transactions and/or attributes that are associated with the template. Template generation module 210 stores in a database references to the template for the identified real-estate property transactions and/or attributes.

At operation 501 (FIG. 5), the computing system retrieves a template based on a received template identifier. For example, template selection module 240 automatically identifies one or more templates associated with a real-estate property transaction received from a user. Alternatively, template selection module 240 receives an identifier from the user. Template selection module 240 searches database 128 for and retrieves one or more templates associated with the identifier. If a template associated with the identifier is itself associated with additional templates, the additional templates are also retrieved.

At operation 502, the computing system obtains real-estate property information. For example, template population module 250 uses an address provided by a user from user interface 600 to search an MLS database for information associated with the real-estate property.

At operation 503, the computing system retrieves identifiers of fields in the retrieved template. Template population module 250 compares the information available from the MLS database for the property with identifiers of fields in the retrieved templates. For example, a template can contain a “seller” field and the MLS database may include a current owner information. Template population module 250 determines that the seller field corresponds to the current owner information and obtains and populates the seller field of the template based on the information from the MLS database. Template population module 250 also determines whether another retrieved template contains the same field (e.g., “seller”) and automatically populates that field with the same information.

At operation 504, the computing system retrieves a portion of the real-estate property information corresponding to the retrieved identifiers of the fields. For example, template population module 250 obtains the owner information from the MLS database corresponding to the seller field in the template.

At operation 505, the computing system populates the fields in the template using the retrieved portion of the real-estate property information. For example, template population module 250 adds the retrieved information from the MLS database into the appropriate field in the template. In some implementations, template population module 250 determines that information for some fields in the template were not found in the MLS database. In such circumstances, template population module 250 presents such fields to the user (e.g., in region 650) for the user to manually input the correct information. Using the information provided by the user in region 650, template population module 250 adds the data into the corresponding fields of the template(s). In some cases, multiple templates share the same fields (e.g., “property address”). In such cases, template population module 250 only presents one occurrence of the fields in region 650 for the user to provide the information. Template population module 250 automatically adds the information provided by the user for the field that appears in multiple templates to each template that has the field.

At operation 506, the computing system retrieves a blank form associated with the template. For example, template population module 250 retrieves a form identifier associated with each retrieved template that has been populated. Using the form identifier, template population module 250 retrieves the corresponding blank form associated with each of the retrieved templates.

At operation 507, the computing system integrates the real-estate property information populated in the fields of the template with corresponding empty fields of the retrieved blank form. For example, template population module 250 determines the location within the retrieved form corresponding to each field of the template. Template population module 250 extracts the text or information from the field of the template and inserts the extracted text or information in the location in the blank form corresponding to the field. In some circumstances, template population module 250 adjusts a size or font of the text or information to fit into the available space on the blank form corresponding to the field.

FIGS. 6 and 7 are illustrative user interfaces 600 and 700 for providing an output from the document integration system 124 according to some embodiments. User interface 600 is presented to a client device 110 to allow a given user to automatically generate one or more real-estate property transaction documents for an identified real-estate property transaction. User interface 600 includes a documents option 610, a contracts option 620, and a markets option 630. A user can select documents option 610 to enter information relevant to a given real-estate property transaction (e.g., a property address and a type of transaction or template identifier) into region 640. Information provided by the user in region 640 is used to identify templates corresponding to the specified real-estate property transaction and to automatically populate corresponding forms associated with the templates.

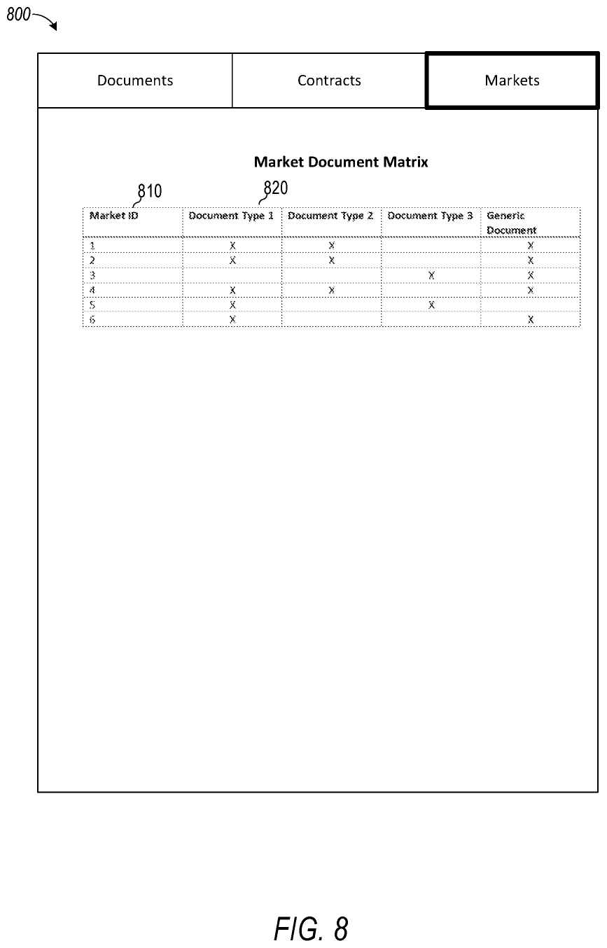

FIG. 8 is an illustrative user interface 800 for providing an output from the document integration system 124 according to some embodiments. In some embodiments, user interface 800 is presented on client device 110. In some embodiments, user interface 800 is presented to a user in response to receiving a user selection of a markets option 630 (FIG. 6). User interface 800 presents a list of different property attributes (e.g., market identifiers) 810 and the corresponding document types 820 associated with the property attributes. Using user interface 800, a user can quickly identify which types of documents are available and are necessary for completing a given real-estate property transaction for a given real-estate property attribute.

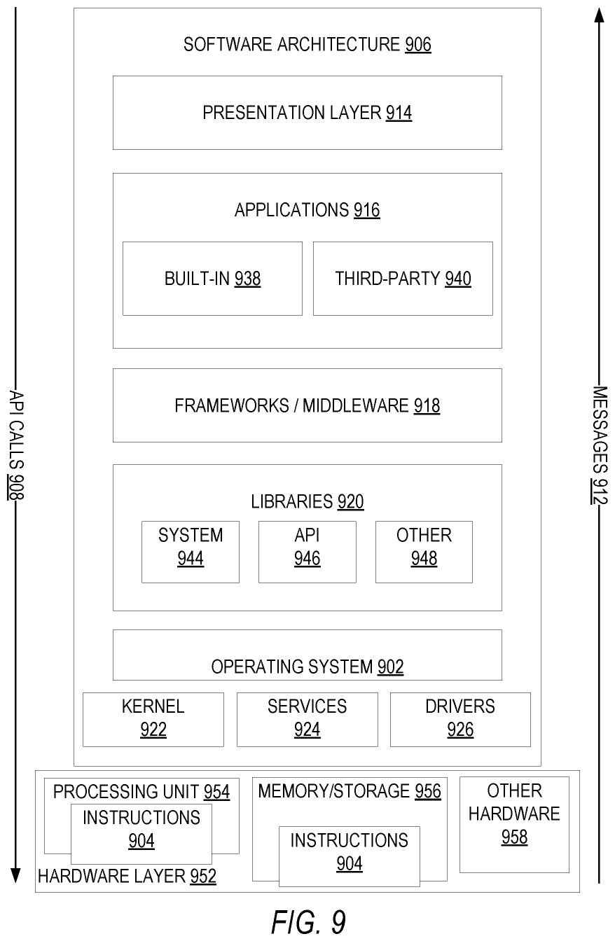

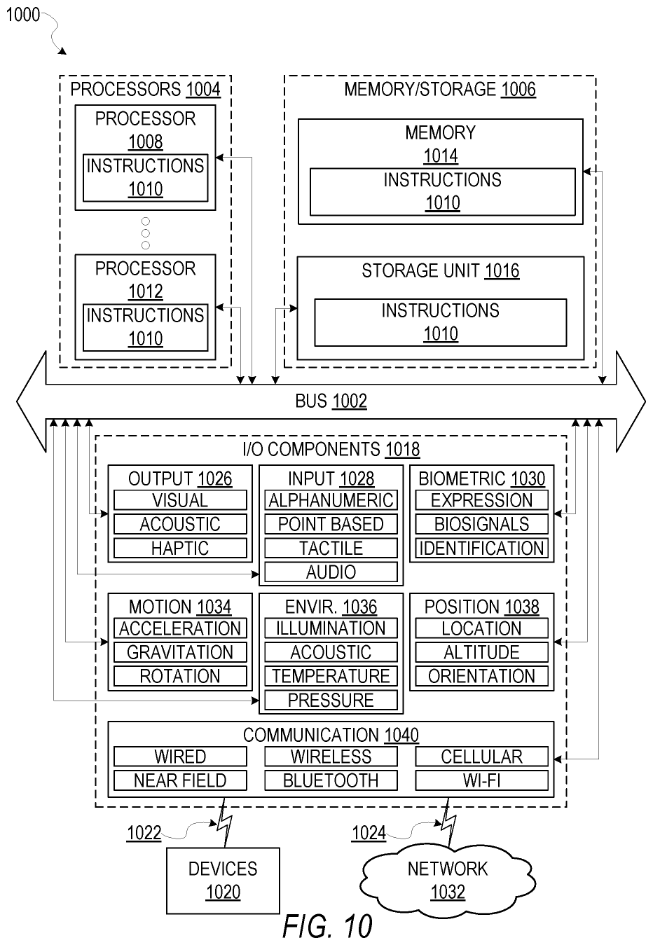

FIG. 9 is a block diagram illustrating software architecture 906, which can be installed on any one or more of the devices described above. For example, in various embodiments, client devices 110 and servers and systems 130, 108, 120, 122, and 124 may be implemented using some or all of the elements of software architecture 906. FIG. 9 is merely a non-limiting example of a software architecture, and it will be appreciated that many other architectures can be implemented to facilitate the functionality described herein. In various embodiments, the software architecture 906 is implemented by hardware such as machine 1000 of FIG. 10 that includes processors 1004, memory/storage 1006, and I/O components 1018. In this example, the software architecture 906 can be conceptualized as a stack of layers where each layer may provide a particular functionality. For example, the software architecture 906 includes layers such as an operating system 902, libraries 920, frameworks 918, and applications 916. Operationally, the applications 916 invoke application programming interface (API) calls 908 through the software stack and receive messages 912 in response to the API calls 908, consistent with some embodiments.

In various implementations, the operating system 902 manages hardware resources and provides common services. The operating system 902 includes, for example, a kernel 922, services 924, and drivers 926. The kernel 922 acts as an abstraction layer between the hardware and the other software layers, consistent with some embodiments. For example, the kernel 922 provides memory management, processor management (e.g., scheduling), component management, networking, and security settings, among other functionality. The services 924 can provide other common services for the other software layers. The drivers 926 are responsible for controlling or interfacing with the underlying hardware, according to some embodiments. For instance, the drivers 926 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 920 provide a low-level common infrastructure utilized by the applications 916. The libraries 920 can include system libraries 944 (e.g., C standard library) that can provide functions such as memory allocation functions, string manipulation functions, mathematic functions, and the like. In addition, the libraries 920 can include API libraries 946 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 920 can also include a wide variety of other libraries 948 to provide many other APIs to the applications 916.

The frameworks 918 provide a high-level common infrastructure that can be utilized by the applications 916, according to some embodiments. For example, the frameworks 918 provide various graphic user interface (GUI) functions, high-level resource management, high-level location services, and so forth. The frameworks 918 can provide a broad spectrum of other APIs that can be utilized by the applications 916, some of which may be specific to a particular operating system 902 or platform.

In an example embodiment, the applications 916 include a home application, a contacts application, a browser application, a book reader application, a location application, a media application, a messaging application, a game application, and a broad assortment of other applications such as a third-party application 940. According to some embodiments, the applications 916 are programs that execute functions defined in the programs. Various programming languages can be employed to create one or more of the applications 916, structured in a variety of manners, such as object-oriented programming languages (e.g., Objective-C, Java, or C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 940 can invoke the API calls 908 provided by the operating system 902 to facilitate functionality described herein.

Some embodiments may particularly include a real estate application. In certain embodiments, this may be a stand-alone application that operates to manage communications with a server system such as third-party servers 130 or server system 108. In other embodiments, this functionality may be integrated with another application. The real estate application may request and display various data related to real estate and may provide the capability for a user to input data related to the objects via a touch interface, keyboard, or using a camera device of machine 1000, communication with a server system via I/O components 1018, and receipt and storage of object data in memory/storage 1006. Presentation of information and user inputs associated with the information may be managed by real estate application using different frameworks 918, library 920 elements, or operating system 902 elements operating on a machine 1000.

FIG. 10 is a block diagram illustrating components of a machine 1000, according to some embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1010 (e.g., software, a program, an application 916, an applet, an app, or other executable code) for causing the machine 1000 to perform any one or more of the methodologies discussed herein can be executed. In alternative embodiments, the machine 1000 operates as a standalone device or can be coupled (e.g., networked) to other machines. In a networked deployment, the machine 1000 may operate in the capacity of a server machine 130, 108, 120, 122, 124, etc., or a client device 110 in a server-client network environment, or as a peer machine in a peer-to-peer (or distributed) network environment. The machine 1000 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1010, sequentially or otherwise, that specify actions to be taken by the machine 1000. Further, while only a single machine 1000 is illustrated, the term “machine” shall also be taken to include a collection of machines 1000 that individually or jointly execute the instructions 1010 to perform any one or more of the methodologies discussed herein.

In various embodiments, the machine 1000 comprises processors 1004, memory 1014, and I/O components 1018, which can be configured to communicate with each other via a bus 1002. In an example embodiment, the processors 1004 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 1008 and a processor 1012 that may execute the instructions 1010. The term “processor” is intended to include multi-core processors 1004 that may comprise two or more independent processors 1004 (also referred to as “cores”) that can execute instructions 1010 contemporaneously. Although FIG. 10 shows multiple processors 1004, the machine 1000 may include a single processor 1004 with a single core, a single processor 1004 with multiple cores (e.g., a multi-core processor 1004), multiple processors 1004 with a single core, multiple processors 1004 with multiples cores, or any combination thereof.

The memory/storage 1006 comprises a main memory 1014, a static memory, and a storage unit 1016 accessible to the processors 1004 via the bus 1002, according to some embodiments. The storage unit 1016 can include a machine-readable medium on which are stored the instructions 1010 embodying any one or more of the methodologies or functions described herein. The instructions 1010 can also reside, completely or at least partially, within the main memory 1014, within the static memory, within at least one of the processors 1004 (e.g., within the processor's cache memory), or any suitable combination thereof, during execution thereof by the machine 1000. Accordingly, in various embodiments, the main memory 1014, the static memory, and the processors 1004 are considered machine-readable media.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium is shown, in an example embodiment, to be a single medium, the term “machine-readable medium” should be taken to include a single medium or multiple media (e.g., a centralized or distributed database, or associated caches and servers) able to store the instructions 1010. The term “machine-readable medium” shall also be taken to include any medium, or combination of multiple media, that is capable of storing instructions (e.g., instructions 1010) for execution by a machine (e.g., machine 1000), such that the instructions 1010, when executed by one or more processors of the machine 1000 (e.g., processors 1004), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 1018 include a wide variety of components to receive input, provide output, produce output, transmit information, exchange information, capture measurements, and so on. In general, it will be appreciated that the I/O components 1018 can include many other components that are not shown in FIG. 10. The I/O components 1018 are grouped according to functionality merely for simplifying the following discussion, and the grouping is in no way limiting. In various example embodiments, the I/O components 1018 include output components 1026 and input components 1028. The output components 1026 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1028 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 1018 include biometric components 1030, motion components 1034, environmental components 1036, or position components 1038, among a wide array of other components. For example, the biometric components 1030 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1034 include acceleration sensor components (e.g., accelerometer), gravitation sensor components, rotation sensor components (e.g., gyroscope), and so forth. The environmental components 1036 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1038 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1018 may include communication components 1040 operable to couple the machine 1000 to a network 1032 or devices 1020 via a coupling 1024 and a coupling 1022, respectively. For example, the communication components 1040 include a network interface component or another suitable device to interface with the network 1032. In further examples, communication components 1040 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 1020 may be another machine 1000 or any of a wide variety of peripheral devices (e.g., a peripheral device coupled via a Universal Serial Bus (USB)).

Moreover, in some embodiments, the communication components 1040 detect identifiers or include components operable to detect identifiers. For example, the communication components 1040 include radio frequency identification (RFID) tag reader components, NFC smart tag detection components, optical reader components (e.g., an optical sensor to detect a one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1040, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 1032 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 1032 or a portion of the network 1032 may include a wireless or cellular network, and the coupling 1024 may be a Code Division Multiple Access (CDMA) connection, a Global System for Mobile communications (GSM) connection, or another type of cellular or wireless coupling. In this example, the coupling 1022 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 1010 are transmitted or received over the network 1032 using a transmission medium via a network interface device (e.g., a network interface component included in the communication components 1040) and utilizing any one of a number of well-known transfer protocols (e.g., Hypertext Transfer Protocol (HTTP)). Similarly, in other example embodiments, the instructions 1010 are transmitted or received using a transmission medium via the coupling 1022 (e.g., a peer-to-peer coupling) to the devices 1020. The term “transmission medium” shall be taken to include any intangible medium that is capable of storing, encoding, or carrying the instructions 1010 for execution by the machine 1000, and includes digital or analog communications signals or other intangible media to facilitate communication of such software.

Furthermore, the machine-readable medium is non-transitory (in other words, not having any transitory signals) in that it does not embody a propagating signal. However, labeling the machine-readable medium “non-transitory” should not be construed to mean that the medium is incapable of movement; the medium should be considered as being transportable from one physical location to another. Additionally, since the machine-readable medium is tangible, the medium may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
receiving, by a processor on server, a selection of a real-estate property transaction associated with a real-estate property;
determining, by the processor, an attribute of the real-estate property;
identifying, based on the determined attribute of the real-estate property, one or more real-estate property transaction documents associated with the selected real-estate property transaction;
identifying a format for the identified one or more real-estate property transaction documents based on the attribute of the real-estate property;
obtaining information associated with the real-estate property transaction; and
automatically populating the one or more real-estate property transaction documents according to the identified format using the obtained information.

2. The computer-implemented method of claim 1, wherein the attribute of the real-estate property comprises at least one of a market associated with the real-estate property, a condition of the real-estate property, or an age of the real-estate property.

3. The computer-implemented method of claim 1, wherein receiving the selection of the real-estate property transaction comprises receiving a request from a computing device to generate a first real-estate property transaction document, the one or more real-estate property transaction documents including at least the first real-estate property transaction document.

4. The computer implemented method of claim 3, wherein the server is a first server that hosts data associated with a purchaser and a seller, and the method further comprises:
storing on a second server to a plurality of templates each associated with a different real-estate property transaction document including the one or more real-estate property transaction documents;
retrieving, with the first server, a document identifier of the first real-estate property transaction document;
transmitting the document identifier to the second server; and
retrieving, by the first server from the second server, the template associated with the retrieved document identifier.

5. The computer-implemented method of claim 4 further comprising associating, on the second server, different types of real-estate property transactions with a corresponding one or more of the different real-estate property transaction documents and a corresponding format of each of the corresponding one or more of the different real-estate property transaction documents.

6. The computer-implemented method of claim 5 further comprising updating the different real-estate property transaction documents in response to detecting a change in regulation.

7. The computer-implemented method of claim 5, wherein the retrieved template is a first template, further comprising:
automatically determining that the selected real-estate property transaction is of a type that is associated with a plurality of the different real-estate property transaction documents including the first real-estate property transaction document; and
retrieving from the second server a second template corresponding to a second real-estate property transaction document in the plurality of the different real-estate property transaction documents.

8. The computer-implemented method of claim 1 further comprising:
identifying a plurality of templates corresponding to the selected real-estate property transaction; and
generating for display the plurality of identified templates.

9. The computer-implemented method of claim 1, wherein obtaining the information comprises:
identifying the user as a purchaser or a seller in the real-estate property transaction; and
retrieving, as the obtained information, previously stored information about the identified user and the real-estate property.

10. The computer-implemented method of claim 9, wherein automatically populating the one or more real-estate property transaction documents comprises automatically filling in fields of a template corresponding to the one or more real-estate property transaction documents using the retrieved previously stored information.

11. The computer-implemented method of claim 10 further comprising:
identifying missing information for at least one of the fields of the template; and
requesting input from via a computing device to supply the missing information.

12. The computer-implemented method of claim 1 further comprising generating for display a preview of the automatically populated one or more real-estate property transaction documents.

13. The computer-implemented method of claim 1, wherein the one or more real-estate property transaction documents includes a first and a second real-estate transaction property document, and the method further comprising:
identifying a field that is common to the first and second real-estate property transaction documents;
automatically populating the field in the first and second real-estate property transaction documents based on the obtained information.

14. The computer-implemented method of claim 1 further comprising:
determining a size of a field in the one or more real-estate property transaction documents;
identifying a portion of the obtained information corresponding to the field; and
adjusting a font of the identified portion to fit the size of the field.

15. The computer-implemented method of claim 1, wherein identifying the format comprises identifying an ordering scheme for the one or more real-estate property transaction documents.

16. A system comprising:
a memory that stores instructions; and
one or more processors on a server configured by the instructions to perform operations comprising:
receiving a selection of a real-estate property transaction associated with a real-estate property;
determining an attribute of the real-estate property;
identifying, based on the determined attribute of the real-estate property, one or more real-estate property transaction documents associated with the selected real-estate property transaction;
identifying a format for the identified one or more real-estate property transaction documents based on the attribute of the real-estate property;
obtaining information associated with the real-estate property transaction; and
automatically populating the one or more real-estate property transaction documents according to the identified format using the obtained information.

17. The system of claim 16, wherein the attribute of the real-estate property comprises at least one of a market associated with the real-estate property, a condition of the real-estate property, or an age of the real-estate property.

18. The system of claim 16, wherein the operations comprising receiving the selection of the real-estate property transaction further comprise receiving a request from a computing device to generate a first real-estate property transaction document, the one or more real-estate property transaction documents including at least the first real-estate property transaction document.

19. The system of claim 18, wherein the server is a first server that hosts data associated with a purchaser and a seller, and wherein the operations further comprise:
storing on a second server to a plurality of templates each associated with a different real-estate property transaction document including the one or more real-estate property transaction documents;
retrieving, with the first server, a document identifier of the first real-estate property transaction document;
transmitting the document identifier to the second server; and
retrieving, with the first server from the second server, the template associated with the retrieved document identifier.

20. A non-transitory computer-readable medium comprising instructions stored thereon that are executable by at least one processor to cause a computing device to perform operations comprising:
receiving a selection of a real-estate property transaction associated with a real-estate property;
determining an attribute of the real-estate property;
identifying, based on the determined attribute of the real-estate property, one or more real-estate property transaction documents associated with the selected real-estate property transaction;
identifying a format for the identified one or more real-estate property transaction documents based on the attribute of the real-estate property;
obtaining information associated with the real-estate property transaction; and
automatically populating the one or more real-estate property transaction documents according to the identified format using the obtained information.
